(19) United States
(12) Patent Application Publication
(10) Pub. No.: US 2020/0391798 A1
(43) Pub. Date: Dec. 17, 2020

(54) Side Skirt Arrangement of a Body of an Electrically Operable Motor Vehicle

(71) Applicant: Daimler AG, Stuttgart (DE)

(72) Inventors: Martin EBNER, Leonberg (DE); Miroslav MARINKOVIC, Stuttgart (DE); Fabio UTZERI, Leonberg (DE)

(73) Assignee: Daimler AG, Stuttgart (DE)

(21) Appl. No.: 16/764,617

(22) PCT Filed: Nov. 9, 2018
(86) PCT No.: PCT/EP2018/080707

§ 371 Date: May 15, 2020

(30) Foreign Application Priority Data
Nov. 17, 2017 (DE) 10 2017 010 670.3

(51) Int. Cl. B62D 25/02; B60K 1/04; B62D 25/20; B62D 21/15

(52) U.S. Cl. CPC B62D 25/025; B60K 1/04; B60Y 2306/01; B62D 21/157; B60K 2001/0438; B62D 25/2036

(57) ABSTRACT

A side skirt arrangement of a body of an electrically operable motor vehicle includes a side skirt which has a hollow profile at least in a longitudinal region and to which a battery support frame is attachable by a first fixing element at a fixing point of the side skirt. The side skirt arrangement also includes a reinforcing element disposed within a cavity of the side skirt, where the reinforcing element extends in a transverse direction of the electrically operable vehicle at least over approximately an entire width of the side skirt between two walls of the side skirt. The reinforcing element is disposed in a region of the fixing point and is disposed in a transverse direction of the electrically operable motor vehicle at least partially overlapping with an attached battery support frame.

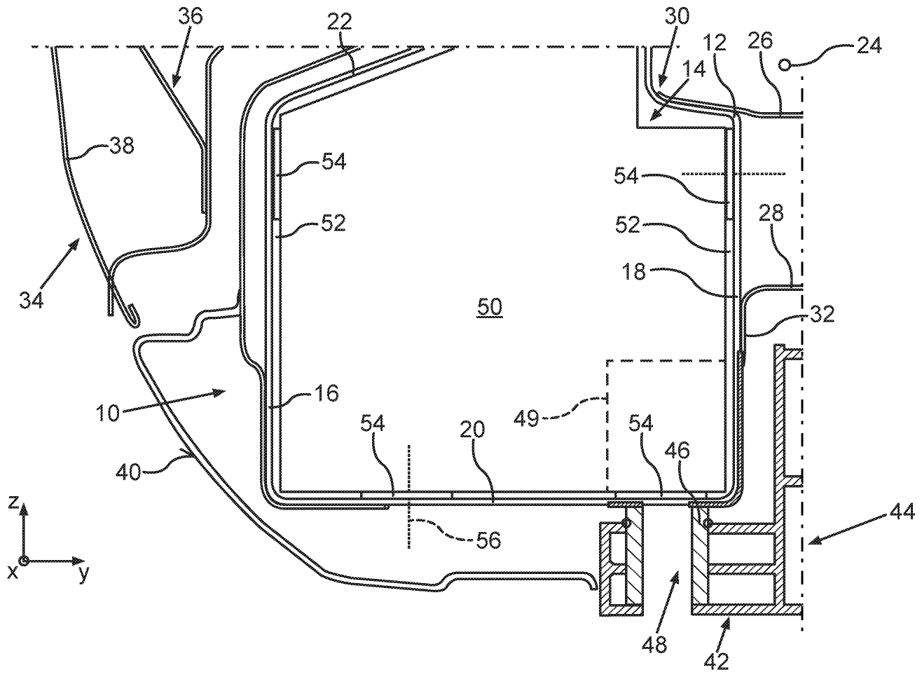

### BACKGROUND AND SUMMARY OF THE INVENTION

The invention relates to side skirt arrangement of a body of an electrically operable motor vehicle and a reinforcing element therefor. Furthermore, the invention relates to a modular system for a body of a motor vehicle and a method for manufacturing such a body.

In contrast to bodies for motor vehicles which are driven by an internal combustion engine, those for motor vehicles with an electric drive are largely subject to different requirements. This is related to a considerable extent to the weight of vehicle batteries, such that, for example, the side skirts of the body are subjected to far higher forces in the event of accident-related force application, which is simulated, for example, with the so-called pole impact test, than is the case with a body for a motor vehicle with a conventional drive concept. At the same time, it is desirable with regard to production costs to design the body for motor vehicles of one vehicle series as far as possible identically across all the different construction variants, i.e., with an internal combustion engine or with an electric drive, for example.

A side skirt arrangement for a body of a motor vehicle with an electric drive is already known from EP 2 468 609 B1, in which the vehicle battery is fixed to the inside or underside of the corresponding side skirt in each case by means of a battery support frame. Within the hollow profile of the respective side skirt, a holding rail extends over a longitudinal region, via which the retaining forces generated by means of respective screw connections are equalized or distributed along the respective side skirt.

A side skirt for a battery-electrically driven motor vehicle emerges from U.S. Pat. No. 8,696,051 B2, the side skirt being designed as a hollow profile in which an energy absorption element designed as an assembly part is arranged, which extends over the entire width of the side skirt between respective side skirt walls. In the event of a side impact of an obstacle, the energy absorption element is deformed and thus ensures reduced stress on the vehicle occupants. Below the energy absorption element, a heavy battery support frame is screwed to the underside of the side skirts.

The object of the present invention is to create a side skirt arrangement, a reinforcing element therefor as well as a modular system and a method for manufacturing a body of a motor vehicle by means of which improved accident characteristics of the body in the region of the side skirts can be implemented.

In order to create a side skirt arrangement of the type mentioned above, by means of which improved accident characteristics of the bodywork in the region of the respective side skirts can be achieved, it is provided in accordance with the invention that an associated reinforcing element is provided within the respective cavity of the corresponding side skirt, which extends over approximately the entire width of the associated side skirt between respective side skirt walls, and in that the reinforcing elements are arranged in the region of the fixing points for the battery support frame and are in each—seen in the motor vehicle transverse direction—at least partially overlapping with the battery support frame. By integrating a respecting reinforcing element in its associated cavity, a respective side skirt is thus created which, on the one hand, takes account of the higher weight in an electrically operated motor vehicle in which the battery support frame is located in the region of the vehicle floor between the side skirts and, on the other hand, also takes account of safety-technological aspects which are required, for example, in the region of the respective side skirt due to the higher vehicle weight. Thus, on the one hand, the static and dynamic forces due to the additional weight of the battery and, on the other hand, the associated higher accident forces, which, for example, have to be absorbed due to the higher mass in the event of a pole impact, can be absorbed in an optimum manner in the region of the side skirts. The fact that the reinforcing elements are arranged in the region of the fixing points for the battery support frame results in a particularly favorable fixing of the battery support frame with an accompanying optimum absorption of the forces acting between the battery support frame or the batteries on the one hand and the respective side skirts on the other hand. By covering the reinforcing elements in the transverse direction of the vehicle with the battery support frame, the latter is covered by the respective reinforcing element at least over part of its height, preferably over its whole height, and is thus suitably protected in the event of a side impact.

The advantage of such reinforcing elements is that they can easily be arranged in the cavity of the side skirts in an electrically powered vehicle and can be omitted accordingly in a vehicle with a different drive concept, for example, an internal combustion engine, as they would otherwise lead to high stiffness of the body in the region of the side skirts. Overall, this has the advantage that one and the same body can be used both for a variant that can be operated by an electric motor and for a variant of a respective motor vehicle that can be operated purely by an internal combustion engine, wherein the reinforcing elements are provided or not depending on the selected drive concept. Overall, this results in obvious advantages in terms of production technology and the associated cost savings.

In the preferred embodiment, it is provided that the at least one reinforcing element per side skirt is designed as an assembly part which, for example, is subsequently inserted into the respective side skirt and fixed there after completion of the body, in particular after dip painting for the application of a corrosion protection coating.

The reinforcing elements themselves preferably extend over approximately the entire width of the associated side skirt between the respective side skirt walls, such that, for example, in the event of a pole impact or similar side impact, the respective forces can be absorbed by the corresponding reinforcing element as early as possible. There are also substantial advantages with regard to static and dynamic forces if the reinforcing element preferably extends over the entire width of the side skirt between the respective side skirt walls.

In a further embodiment of the invention, it has been shown to be advantageous if the reinforcing elements cover the fixing points for the battery support frame. This means that the fixing points are quasi framed by means of the reinforcing elements, if necessary with the aid of the side skirt base and the side skirt wall, such that these are also especially protected by means of the reinforcing elements in the event of a side impact, thus reducing the risk of destruction of the respective fixing point and an accompanying detachment of the battery support frame from the side skirt. The fixing points are therefore preferably each located in a quasi-protected space.

A further advantageous embodiment of the invention is that the reinforcing elements have respective receptacles for fixing elements for the battery support frames. Thus, for example, a respective receptacle in the form of a fixing nut or the like can be provided or integrated on the respective fixing element, in which the associated fixing element of the battery support frame, for example a screw fixing the latter, is inserted. A reinforcing element designed in this way enables a particularly stable connection of the battery support frame directly to the respective reinforcing element and a simple and cost-effective design of the entire side skirt arrangement.

Alternatively, the reinforcing elements can also have respective recesses for the fixing elements for the battery support frame. Thus, the respective fastening elements, e.g., fastening nuts, can be designed separately from the respective reinforcing element and, for example, attached to the corresponding side skirts on the bodyshell side, e.g., by welding, gluing or the like. Such a design has advantages, for example, if the respective fixing element, e.g., the respective fixing nut, is also to be used in non-electrically operated variants of the motor vehicle or if the fastening nut is to be arranged on the shell before passing through a cathodic dip-painting or similar. However, it is also conceivable that the fixing element should be provided at the appropriate position after the body has passed through the cathodic dip painting process in the course of final assembly. The respective reinforcing element can have a depression, a groove, a recess or similar recess within which the respective fastening element can be accommodated after the reinforcing element has been arranged.

A further advantageous embodiment of the invention provides that respective distancing elements are arranged between the respective reinforcing element and corresponding side skirt walls. Thus, an optimal support of the respective reinforcing element within the respective cavity of the corresponding side skirt can be achieved. The distancing elements also serve in particular to reduce the bearing contact surface between the respective reinforcing element and the side skirt, such that in the event of any relative movement between these parts, for example also when the reinforcing element is pushed into the cavity of the side skirt, the risk of extensive damage to any corrosion protection coating that may be provided is avoided.

A further advantageous embodiment of the invention provides that the respective reinforcing element at least substantially fills the entire hollow cross-section of the hollow profile of the respective side skirt. By means of the respective reinforcing element, the side walls of the side skirts are thus not only supported and thereby in the transverse direction of the vehicle (y-direction), but also in the vertical direction of the vehicle (z-direction) between the bottom of the side skirts and the top of the side skirts. In this way, a particularly favorable support of the respective reinforcing element can be achieved and thus also a particularly favorable stiffening of the respective side skirt.

Finally, a further embodiment of the invention provides that the respective reinforcing element is fixed to the assigned side skirt by means of fixing elements. This allows the reinforcing elements to be positioned particularly favorably and stiffly within the respective side skirt.

The advantages mentioned above in connection with the side skirt arrangement according to the invention apply in the same way to the reinforcing element.

The invention also includes a modular system for a body of a motor vehicle, which comprises at least one electrically operable structural variant and one structural variant operable by an internal combustion engine, having respective side skirts, which cover all structural variants and have a hollow profile at least in a respective longitudinal region. In order to create respective bodies for the electrically operable structural variants and for the structural variants of the respective body operable by internal combustion engine, which have a particularly favorable, respective accident behavior, it is provided according to the invention that in the structural variant operable by internal combustion engine, the respective side skirts have a profile in the corresponding longitudinal region within which no reinforcing element is arranged, and in that, in the electrically operable structural variant of the motor vehicle, in which a battery support frame can be fixed to the side skirts by means of respective fixing elements at respectively assigned fixing points of the side skirts, an associated, variant-specific reinforcing element is provided within the respective cavity of the corresponding side skirt, the reinforcing element extending at least over approximately the entire width of the assigned side skirt between respective side skirt walls.

The modular system according to the invention thus comprises respective side skirts which, in the case of the internal combustion engine variant of the motor vehicle, have no reinforcing element within their respective cavity, and which, in the case of the electrically operable variant, have at least one respective reinforcing element within their respective cavity. Thus a body is created which can be adjusted in the region of the respective side skirts in a simple manner to the respective construction variant of the motor vehicle—either the combustion engine operable one or the electrically operable one—by providing corresponding reinforcing elements within the cavity of the respective side skirts—or not. This means that the body of the car can be used across structural variants for both an electrically operable and an internal combustion engine operable variant, wherein only the respective side skirts are supplemented with the respective reinforcing elements as required. This makes it possible to have a vehicle which has an almost identical body across all its structural variants, which can only be supplemented selectively.

The advantage of such a modular system is, in particular, that considerable cost advantages clearly emerge. By way of example, the respective reinforcing element can only be inserted during the assembly process, such that, for example, the shell of the body can occur in the same way for all drive concepts across all structural variants. The individual adjustment, in particular to the electrically operable structural variant, is then preferably carried out during final assembly, in which, for example, the respective reinforcing elements are positioned and fixed in the corresponding cavities of the corresponding side skirts before the battery support frame is fixed in place.

The advantages mentioned above in connection with the modular system according to the invention apply in the same way to the method for manufacturing a body of a motor vehicle.

Further advantages and details of the invention emerge from the following description of a preferred exemplary embodiment and by means of the drawing. The single FIGURE shows, in sections, a sectional view of a side skirt arrangement of a body of an electrically driven motor vehicle along a sectional plane extending in the vehicle vertical direction (z-direction) and in the vehicle transverse direction (y-direction). A side skirt is recognizable here, which extends in the usual manner on the corresponding vehicle side in the longitudinal direction of the vehicle and horizontally between a front and rear wheel arch. In the present case, the side skirt is designed from one or more metal sheets in a metal sheet construction manner, the metal sheets being joined together by welding or gluing, for example. Other designs and construction methods are of course also conceivable.

Other objects, advantages and novel features of the present invention will become apparent from the following detailed description of one or more preferred embodiments when considered in conjunction with the accompanying drawings.

### BRIEF DESCRIPTION OF THE DRAWING

The FIGURE is a sectional view of a side skirt arrangement of a body of an electrically driven motor vehicle along a sectional plane extending in the vehicle vertical direction (z-direction) and in the vehicle transverse direction (y-direction).

### DETAILED DESCRIPTION OF THE DRAWING

In particular, it is recognizable from the FIGURE that the box-like side skirt 10 has a hollow profile 12 and a cavity 14, at least over a longitudinal region shown here. The hollow profile 12 is formed centrally or on the inside by respective side skirt walls 16, 18, which in this case extend at least substantially in the vehicle vertical direction (z-direction) and in the vehicle longitudinal direction (x-direction). On the underside, the two side skirt walls 16, 18 are formed in one piece with one another via a lower side skirt wall 20. On the upper side, the hollow profile 12 of the side skirt 10 has a complex, angled course of a corresponding side skirt wall 22, which also connects the respective side skirt walls 16, 18 in one or more parts.

From a vehicle floor 24, which adjoins the respective side skirts 10 on the inside, two sheet metal plates or sheet metal walls 26, 28 can be recognized in the present case, which are fixed to a section 30 of the upper side skirt wall 22 or via an angle 32 on the inside to the inner side skirt wall 18. In addition, between the side skirts 10 on each side of the vehicle, respective cross members extend, which are not, however, explicitly recognizable in the present case.

Furthermore, the FIGURE shows, on the upper side and the outer side of the side skirt 10, a lower end of an assigned side door 34, of which an inner door panel 36 and an outer door panel 38 are substantially recognizable. On the underside, a trim part 40, consisting of plastic, of the side skirt 10 connects to the side door 34.

Furthermore, the FIGURE shows a sectional view through a profile 42 of an otherwise unrecognizable battery support frame 44, through which a plurality of battery modules is accommodated, which are fixed to the body by means of the battery support frame 44. More precisely, the respective profiles 42 are arranged in a frame-like manner around the battery pack and thus within a rectangular opening bordered by the respective side skirts 10 and a respective front and rear cross member from below. It is recognizable that a corresponding connector 46 is inserted into the respective profile element 42 to be fixed to one of the two side skirts 10, through which a fixing element, present in the form of a fixing screw, can be inserted.

At respective fixing points 48, in the present case thus at least in the region of the respective connectors 46, a respective reinforcing element 50 is provided within the respective cavity of the corresponding side skirt 10. This reinforcing element 50 can, for example, be formed as a box-like sheet metal component which is designed in one or several parts. Likewise, the respective reinforcing element 50 can be designed as a cast component or as a metal component of different design, which is designed as a filling material or, if necessary, at least partially hollow. If necessary, a solution made of a plastic, for example a fibre-reinforced plastic, is also conceivable.

In the present case, the respective reinforcing element 50 extends in the longitudinal direction of the vehicle (x-direction) at least over a corresponding longitudinal region of the respective cavity 14 of the assigned side skirt 10. In the concrete exemplary embodiment, for example, one reinforcing element 50 can be provided in each of a front and a rear end region of the respective side skirt 10, such that a total of four reinforcing elements 50 are provided, which are arranged in the region of the respective fixing point 48 of the battery frame 44. A different number of such reinforcing elements 50 is of course also conceivable.

The reinforcing element 50 shown here extends in the transverse direction of the vehicle (y-direction) at least approximately over the entire width of the side skirt 10 between the respective side skirt walls 16, 18 extending in the longitudinal direction of the vehicle (x-direction) and in the vertical direction of the vehicle (z-direction). A respective intermediate gap 52 remaining here between the side skirt walls 16, 18 and the reinforcing element 50 is bridged by a respective distancing element 54, such that both side skirt walls 16, 18 are supported towards the reinforcing element 50. Also on the underside, respective distancing elements 54 are provided, such that here too a corresponding intermediate gap 52 is provided between the reinforcing element 50 and the lower side skirt wall 20. Such distancing elements 54 can also be provided at the top between the upper side of the reinforcing element 50 and the upper side skirt wall 22. In this case, the distancing elements 54 substantially serve to bridge the respective intermediate gap 52 which, however, is needed so that the reinforcing element 50 can be inserted into the respective side skirt 10 subsequently, i.e., in particular after the body shell and a cathodic dip-painting associated therewith, for example in the course of the final assembly. A slight clearance is required for this, which can then be bridged by the respective distancing element 54. The distancing element 54 itself can, for example, be designed as a metal or plastic part, wherein a liquid or foamy component which subsequently cures is also conceivable. Another particular advantage of the spacer elements 54 is that they reduce the contact surface when the reinforcing element 50 is inserted into the side skirt, such that there is only a risk of abrasion of the cathodic dip-painting and/or other coating on a reduced inner surface of the respective side skirt.

The battery support frame 44 is fixed in place by means of an appropriate fixing element, in particular a fixing screw, in the region of the fixing point 48 on the shell side. By way of example, each side skirt 10 is provided with seven corresponding fixing elements or fixing screws. Each of these fixing elements passes through the lower side skirt wall 20 in a different way.

In a first solution, for example, it is conceivable that the respective fastening element of the battery support frame 48 is directly connected to the respective reinforcing element 50. For this purpose, the reinforcing element 50 can, for example, have a fixing thread or fixing nut which is integrated into the reinforcing element 50 or fixed to it.

In another variant, it is conceivable, for example, that a fixing nut is designed separately from the reinforcing element 50 and is either attached to the side skirt 10 on the shell side, for example on the inside of the lower side skirt wall 20 by welding, gluing or the like, or the fastening nut is also subsequently inserted as an assembly part after the shell has been completed or after the body has passed through the cathodic dip-painting process on the inside of the cavity 14 in order to be connected to the fixing element in the form of the fixing screw on the sides of the battery support frame 44. In the case of the latter variants, a respective recess for the corresponding fixing element, e.g., fixing nuts, can be provided in the region of the reinforcing element.

The reinforcing element 50 can, for example, be pre-fixed within the cavity 14 of the side skirt 10 by means of respective, indicated fixing screws 56. This variant is particularly recommended if the respective reinforcing element 50 is not directly connected to the fixing screw on the sides of the battery support frame 44. In the case of the latter variant, the fixing screws 56 can also be dispensed with.

The reinforcing elements 50 provided here can be used in particular to take account of the fact that, in a variant of the motor vehicle body in which the latter is driven by an internal combustion engine or the like, the weight of the vehicle is much lower, in particular in the region between the side skirts below the vehicle floor, such that, for example, in the event of a side impact, much lower forces act in the region of the side skirts 10. For this reason, the corresponding side skirt reinforcement can be dispensed with in such a variant of the body.

If, on the other hand, the body is intended for an electrically driven motor vehicle, in which, as a result of the batteries arranged between the side skirts 10 to supply an electric motor, the weight in this region is considerably higher, a side skirt arrangement can be created overall by inserting the reinforcing elements 50, in which, for example, side impact forces or pole impact forces can be absorbed much better. In addition, the reinforcing elements 50 result in considerable stiffening of the body with regard to the static and dynamic forces acting on the respective side skirts 10 or the body as a whole.

Due to the modular system created in this way of the body of the motor vehicle, in which corresponding reinforcing elements 50 are provided or not depending on the structural variant, an optimal adaptability to the respective vehicle weight or the respective accident-related, static or dynamic forces is thus possible without, for example, with regard to a construction variant having an internal combustion engine, an over-dimensioning of the side skirt arrangement or, with regard to an electrically operable variant, an under-dimensioning of the side skirt arrangement.

The respective reinforcing elements 50 can preferably not already be inserted in the body shell of the car, but only in the final assembly. This means that the body shell can already be completely manufactured and completed in the course of cathodic dip painting, such that the reinforcing elements 50 can only be inserted into the respective hollow profile 12 of the corresponding side skirt 10 from the front or rear during final assembly. The respective intermediate gaps 52 between the side skirt walls 16 to 22 on the one hand and the reinforcing element 50 on the other hand are preferably selected in such a way that simple assembly is possible on the one hand and on the other hand that it is avoided that a paint coating of the body, which is applied during cathodic dip painting, for example, is damaged when the reinforcing elements 50 are inserted.

This makes it easy to adapt to the side skirt arrangement or the body to the respective vehicle concept.

1.-10. (canceled)

11. A side skirt arrangement of a body of an electrically operable motor vehicle, comprising:
a side skirt which has a hollow profile at least in a longitudinal region and to which a battery support frame is attachable by a first fixing element at a fixing point of the side skirt; and
a reinforcing element disposed within a cavity of the side skirt, wherein the reinforcing element extends in a transverse direction of the electrically operable vehicle at least over approximately an entire width of the side skirt between two walls of the side skirt;
wherein the reinforcing element is disposed in a region of the fixing point and is disposed in a transverse direction of the electrically operable motor vehicle at least partially overlapping with an attached battery support frame.

12. The side skirt arrangement according to claim 11, wherein the reinforcing element covers the fixing point.

13. The side skirt arrangement according to claim 11, wherein the reinforcing element has a receptacle for the fixing element.

14. The side skirt arrangement according to claim 11, wherein the reinforcing element has a recess for the fixing element.

15. The side skirt arrangement according to claim 11 further comprising a distancing element disposed between the reinforcing element and a one of the two walls.

16. The side skirt arrangement according to claim 11, wherein an entire hollow cross-section of the hollow profile is at least substantially filled by the reinforcing element.

17. The side skirt arrangement according to claim 11, wherein the reinforcing element is fixed to the side skirt by a second fixing element.

18. A modular system of a body of a motor vehicle which comprises an electrically operably structural variant and a structural variant operable by an internal combustion engine, comprising:
a side skirt;
wherein if the motor vehicle is the structural variant operable by the internal combustion engine, the side skirt has a hollow profile in a longitudinal region;
wherein if the motor vehicle is the electrically operable structural variant, to which a battery support frame is attachable to the side skirt by a fixing element at a fixing point of the side skirt, a reinforcing element is disposed within a cavity of the side skirt and wherein the reinforcing element extends in a transverse direction of the electrically operable structural variant at least over approximately an entire width of the side skirt between two walls of the side skirt.

19. A method for manufacturing a modular system of a body of a motor vehicle which comprises an electrically operably structural variant and a structural variant operable by an internal combustion engine, comprising the steps of:
providing a side skirt;
providing the side skirt with a hollow profile in a longitudinal region if the motor vehicle is the structural variant operable by the internal combustion engine; and
disposing a reinforcing element within a cavity of the side skirt if the motor vehicle is the electrically operable structural variant, wherein a battery support frame is attachable to the side skirt by a fixing element at a fixing point of the side skirt and wherein the reinforcing element extends in a transverse direction of the electrically operable structural variant at least over approximately an entire width of the side skirt between two walls of the side skirt.
